(19) United States
(12) Patent Application Publication
(10) Pub. No.: US 2010/0329460 A1
(43) Pub. Date: Dec. 30, 2010

(54) METHOD AND APPARATUS FOR ASSURING ENHANCED SECURITY

(75) Inventor: Radia J. Perlman, Sammamish, WA (US)

Correspondence Address: PVF -- ORACLE AMERICA, INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/494,486

(22) Filed: Jun. 30, 2009

(51) Int. Cl. H04L 9/00; H04L 9/06; G06F 21/00

(52) U.S. Cl. 380/259; 380/29; 726/1

(57) ABSTRACT

Some embodiments provide a system to assure enhanced security, e.g., by assuring that information is not revealed over a covert channel. All communications between a source system and a destination system may pass through an intermediate system. In some embodiments, the intermediate system may perform an additional level of blinding to ensure that the source system does not covertly reveal information to the destination system. In some embodiments, the intermediate system may request the source system to perform a modification operation, and then check if the source system performed the modification operation. Examples of the modification operation include a blinding operation and a cryptographic hashing operation.

### BACKGROUND

1. Field

This disclosure generally relates to information security. More specifically, this disclosure relates to techniques and systems for assuring enhanced security, e.g., by preventing a system from using a covert channel to communicate information.

2. Related Art

Information privacy plays a critical role in modern democratic societies. For example, it is indisputable that voting information must be kept private to ensure the integrity of a democratic election. It is not surprising therefore, that information privacy has been called a fundamental human right.

Due to the rapid advances in computing and communication technologies, the ability to collect and exploit private information has grown exponentially. As a result, it has become critically important to enable individuals and organizations to protect private information.

Whenever two or more parties enter into a transaction, the parties often need to exchange information. A transaction is usually accompanied by an implicit or explicit privacy agreement about what information is to be collected and how the information is to be used. If a party negligently or intentionally collects more information than what was implicitly or explicitly agreed upon, the party may be considered to be in breach of the privacy agreement. An injured party may be able to bring a lawsuit against the breaching party to obtain monetary compensation. However, pursuing such legal actions can be costly, and moreover, monetary compensation may not be sufficient to compensate for the damage caused by the breach.

Hence, it is desirable to enable a party to ensure that the information being communicated over a channel is consistent with the implicit or explicit privacy agreement. More generally, it is desirable to enable a party to assure enhanced security, e.g., by assuring that information is not being communicated over a covert channel.

### SUMMARY

Some embodiments of the present invention provide a system to assure enhanced security, e.g., by assuring that information is not revealed over a covert channel.

In some embodiments, an intermediate system can receive blinded information from a source system, which is destined to the destination system. The blinded information may have been generated by at least performing a blinding operation on private information. However, the blinding operation may not be trusted by an intermediate system. Next, the intermediate system may perform another blinding operation on the blinded information to obtain multiple-blinded information. The intermediate system can then send the multiple-blinded information to the destination system. Note that, by performing the additional blinding operation, the intermediate system can prevent the destination system from obtaining the private information. Once the destination system transforms the multiple-blinded information and sends the result to the intermediate system, the intermediate system can perform an unblinding operation and send the result to the source system. Note that the blinding operations must commute with the transformation operation that the destination system performs.

In some embodiments, an intermediate system can receive information from a source system, which is destined to a destination system. Next, the intermediate system can request the source system to perform a modification operation on the information. The intermediate system can then receive the modified information from the source system. Next, the intermediate system can check that the source system performed the requested modification operation.

Specifically, the intermediate system can check that the source system performed the requested modification operation by performing the modification operation on the information, and comparing the result with the modified information that was received from the source system. If the modification operation has an inverse, the intermediate system can check that the source system performed the requested modification operation by performing the inverse of the modification operation on the modified information, and comparing the result with the original information that was received from the source system.

If the intermediate system determines that that the source system performed the requested modification, the intermediate system can send the modified information to the destination system. On the other hand, if the intermediate system determines that that the source system did not perform the requested modification, the intermediate system can report an error.

The destination system can perform a transformation operation on the modified information to obtain transformed-and-modified information. The destination system can then send the transformed-and-modified information to the intermediate system. If the modification operation has an inverse, and the modification operation commutes with the transformation operation, the intermediate system can perform the inverse of the modification operation on the transformed-and-modified information to obtain transformed information. Next, the intermediate system can send the transformed information to the source system.

Specifically, in some embodiments, an intermediate system can receive encrypted information from the source system, which is destined to the destination system. The encrypted information may be generated by at least encrypting the private information by performing an asymmetric encryption operation using an asymmetric key associated with the destination system. Next, the intermediate system can request the source system to perform a blinding operation on the encrypted information to obtain blinded information. Performing the blinding operation on the encrypted information prevents the destination system from decrypting the encrypted information to obtain the private information. Note that the blinding operation must commute at least with the asymmetric encryption operation. The intermediate system can then receive the blinded information from the source system, and check that the source system performed the blinding operation, thereby ensuring that the private information is not revealed to the destination system. Note that the asymmetric decryption operation is an example of a transformation operation, and the blinding operation is an example of a modification operation which has an inverse, and which commutes with the transformation operation.

In some embodiments, an intermediate system can receive a nonce from a source system which is to be used in a cryptographic protocol between a source system and a destination system. The intermediate system can then randomly choose another nonce, and request the source system to cryptographically hash the two nonces to generate a hashed nonce. Next, the intermediate system can receive the hashed nonce from the source system, and check that the source system obtained the hashed nonce by cryptographically hashing the two nonces. Note that, cryptographically hashing the two nonces ensures that neither the source system nor the intermediate system is able to cause a non-random nonce to be used in the cryptographic protocol. Note that the hashing operation is an example of a modification operation.

### BRIEF DESCRIPTION OF THE FIGURES

FIG. 1 illustrates how private information can be covertly revealed when a user consumes content.

FIG. 2A presents a flowchart that illustrates a process for an intermediate system to ensure that a source system does not reveal private information to a destination system in accordance with an embodiment of the present invention.

FIG. 2B illustrates how an intermediate system can ensure that a source system does not reveal private information to a destination system in accordance with an embodiment of the present invention.

FIG. 3A presents a flowchart which illustrates a process for an intermediate system to ensure that a source system does not reveal private information to a destination system in accordance with an embodiment of the present invention.

FIG. 3B illustrates how an intermediate system can ensure that a source system does not reveal private information to a destination system in accordance with an embodiment of the present invention.

FIG. 4A presents a flowchart that illustrates a process to enable an intermediate system to ensure that a nonce which is being used in a cryptographic protocol between a source system and a destination system is randomly chosen, thereby ensuring that the source system cannot use the nonce to covertly reveal private information, in accordance with an embodiment of the present invention.

FIG. 4B illustrates how an intermediate system can ensure that a nonce that is being used in a cryptographic protocol between a source system and a destination system is randomly chosen in accordance with an embodiment of the present invention.

FIG. 5 illustrates a computer system in accordance with an embodiment of the present invention.

FIG. 6 illustrates an apparatus in accordance with an embodiment of the present invention.

### DETAILED DESCRIPTION

The following description is presented to enable any person skilled in the art to make and use the embodiments. Various modifications to the disclosed embodiments will be readily apparent to those skilled in the art, and the general principles defined herein are applicable to other embodiments and applications without departing from the spirit and scope of the present disclosure. Thus, the present invention is not limited to the embodiments shown, but is to be accorded the widest scope consistent with the principles and features disclosed herein.

The data structures and code described in this disclosure can be partially or fully stored on a computer-readable storage medium and/or a hardware module and/or hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed.

The methods and processes described in this disclosure can be partially or fully embodied as code and/or data stored in a computer-readable storage medium or device, so that when a computer system reads and executes the code and/or data, the computer system performs the associated methods and processes. The methods and processes can also be partially or fully embodied in hardware modules or apparatuses, so that when the hardware modules or apparatuses are activated, they perform the associated methods and processes. Note that the methods and processes can be embodied using a combination of code, data, and hardware modules or apparatuses.

### Information Privacy

The rapid advances in computing and communication technologies have had an impact on almost all aspects of our lives—from buying cameras to buying real estate, and from reading a newspaper to watching a movie. Unfortunately, these technological advances have also made it much easier to collect and exploit private information.

Hence, it is critical to develop techniques and systems to enable individuals and organizations to protect their privacy. Specifically, some embodiments of the present invention enable a user to ensure that a device or system does not communicate private information over a covert channel.

### Public-Key Cryptography and Certificates

In public-key cryptography (also known as asymmetric cryptography), encryption and decryption is accomplished using a key pair: a private key and a public key. A message encrypted using one of the keys can be decrypted using the other key. Note that, although the keys are related, it is computationally impractical to derive one key from the other. Hence, a user can widely distribute the public key without compromising the private key.

Public-key cryptography can be used to ensure confidentiality and authenticity. To ensure confidentiality, a sender can encrypt a message using the recipient's public key, and the recipient can decrypt the message using the recipient's private key. To ensure authenticity, a sender can digitally sign the message using the sender's private key, and the recipient can verify the digital signature using the sender's public key.

A certificate is a digitally signed document that certifies that a certain piece of information is true. The entity that issues the certificate is usually called a certificate authority (CA). For example, a CA can issue a certificate to certify that a key pair is associated with a particular user, that the key pair was generated on a particular date, that the key pair was generated by a particular entity, and/or any other information that is desired to be certified. Public key infrastructure (PKI) is a certification system that uses public-key cryptography to issue certificates.

### Blinded Encryption and Decryption

Blinded encryption and decryption allow device D_{A} to request decryption from device D_{B}, of a piece of data X which is encrypted with a public key belonging to device D_{B}, without allowing device D_{B} to see data X. Further details on blinded encryption/decryption can be found in U.S. Pat. No. 7,363,499, entitled “Blinded Encryption and Decryption,” by Radia Perlman, issued on 22 Apr. 2008, which is hereby incorporated by reference to describe blinded encryption and decryption.

The following sections describe how an intermediate device can perform an additional level of blinding for three asymmetric encryption and decryption techniques: RSA, Diffie-Hellman, and Pohlig-Hellman. In these sections, devices D_{A} and D_{B} refer to the two devices which perform the asymmetric encryption and decryption operations, and device D_{C} sits between these two devices and performs the additional level of blinding.

RSA

RSA is a well-known asymmetric encryption and decryption technique that is named after the initials of the three authors of the research paper in which it was first described. Further details of RSA can be found in U.S. Pat. No. 4,405,829, entitled “Cryptographic communications system and method,” by inventors Ronald L. Rivest, Adi Shamir, and Leonard M. Adleman, issued on 20 Sep. 1983.

Blinded encryption and decryption can be performed for RSA as follows. Device D_{A} has M encrypted with D_{B}'s RSA public key (e, n). That means D_{A} has M^{e} mod n. To retrieve M through blind decryption, D_{A} chooses a random number, say “R₁,” encrypts with D_{B}'s public key to obtain R₁^{e} mod n, multiplies that by M^{e} mod n, and sends the result R₁^{e} [symbol] M^{e} mod n to D_{B}, along with the identifier of the private key that D_{B} should use, say “i.” In other words, D_{A} sends the message “R₁^{e} [symbol] M^{e} mod n, i” to D_{B} via D_{C}.

Note that if D_{B} does not have R₁, it will not be able to retrieve M. However, if D_{A} colludes with D_{B} so that D_{B} can determine R₁, D_{B} can retrieve M by performing a decryption and an unblinding operation.

However, D_{C} can perform an additional blinding operation to ensure that even if D_{A} and D_{B} collude, D_{B} will not be able to retrieve M. To perform an additional blinding operation, D_{C} first retrieves D_{B}'s i^{th} public key to get (e, n). Next, D_{C} chooses a random number R₂, computes R₂^{e} mod n, and multiplies the quantity in the message, namely, R₁^{e}·M^{e} mod n, by R₂^{e} mod n to obtain the message: “R₁^{e} [symbol] R₂^{e} [symbol] M^{e} mod n,i.” D_{C} then sends the message to D_{B}.

Next, D_{B} operates on R₁^{e} [symbol] R₂^{e} [symbol] M^{e} mod n with its private key (d, n), which it selects based on the value of “i,” to obtain R₁^{ed} [symbol] R₂^{ed} [symbol] M^{ed} mod n which results in R₁ [symbol] R₂ [symbol] M mod n because e and d are inverses. D_{B} then sends R₁ [symbol] R₂ [symbol] M mod n back to D_{A}. Note that, even if D_{B} could determine R₁, it would be unable to retrieve M, because D_{B} does not know R₂.

To perform the unblinding operation, D_{C} intercepts the message on the way back, divides by R₂ mod n, to obtain R₁ [symbol] M, and sends the result back to D_{A}. Finally, D_{A} divides by R₁ mod n to obtain M. Note that the additional level of blinding and unblinding operations enables D_{C} to ensure that M is not revealed to D_{B} even when D_{A} and D_{B} collude. Note that the above-described technique can be extended to multiple levels of blinding.

Diffie-Hellman

Diffie-Hellman is a well-known cryptographic protocol that allows one party to exchange a secret key with another party over an insecure communication channel. Further details of Diffie-Hellman can be found in U.S. Pat. No. 4,200,770, entitled “Cryptographic apparatus and method,” by inventors Martin E. Hellman, Bailey W. Diffie, Ralph C. Merkle, issued on 29 Apr. 1980.

D_{B}'s public key is g^{x} mod p, D_{B}'s private key is x, and parameters g and p are public. To encrypt Musing D_{B}'s public key, a system can choose a random number y, compute g^{y} mod p, and raise D_{B}'s public key to y to obtain g^{xy} mod p. Next, g^{xy} mod p is used as an encryption key (e.g., an Advanced Encryption Standard key) to encrypt M, to obtain {M}g^{xy} mod p, where the notation {T}K denotes the result of encrypting text T with key K. The random number y and the key g^{xy} mod p can be deleted. Next, D_{A} can be given the encrypted message {M}g^{xy} mod p, and the value g^{y} mod p.

In blinded decryption, D_{A} obtains the secret key g^{xy} mod p without disclosing the secret key to D_{B} as follows. D_{A} chooses a value a, and raises g^{y} mod p to a, and performs modulo p on the result, to obtain g^{ya} mod p. Next, D_{A} sends that, along with the identifier i of the particular public key pair, to D_{B}.

If D_{C} wants to ensure that D_{A} cannot collude with D_{B} to enable D_{B} to obtain the key g^{xy} mod p, D_{C} can perform an additional level of blinding as follows. D_{C} intercepts the message that was sent from D_{A} to D_{B}, chooses a value c, raises g^{ya} mod p to c, and performs modulo p on the result, to obtain g^{yac} mod p. Next, D_{C} sends that value, along with i, to D_{B}.

D_{B} applies its i^{th} private key, meaning that it raises g^{yac} mod p to x, and performs a modulo p operation on the result, to obtain g^{yacx} mod p. Next, D_{B} sends this value back to D_{A}. Note that, even if D_{B} and D_{B} had colluded to enable D_{B} to determine a, D_{B} would not have been able to determine the secret key g^{xy} mod p, because D_{B} does not know c.

D_{C} intercepts the message, raises the result to c⁻¹, performs a modulo p operation, and sends the resulting value, g^{yax} mod p to D_{B}. D_{B} then raises the value to a⁻¹, performs a modulo p operation to obtain g^{xy} mod p, which is the secret key D_{B} needs to decrypt {M}g^{xy} mod p. Note that the above-described technique can be extended to multiple levels of blinding.

Pohlig-Hellman

Pohlig-Hellman is a technique for computing discrete logarithms in a multiplicative group whose order is a smooth integer. This technique can be used as the basis for an asymmetric encryption and decryption process, as explained below. Further details of the Pohlig-Hellman technique can be found in “An Improved Algorithm for Computing Logarithms over GF(p) and its Cryptographic Significance,” IEEE Transactions on Information Theory, vol. 24, pp. 106-110, 1978.

In Pohlig-Hellman, blinding must be done both for encryption and decryption. In this scheme, device D_{B} has two secret numbers, x and x⁻¹, which are exponentiative inverses modulo p. The encryption operation is performed using x, and the decryption operation is performed using x⁻¹. Note that device D_{B} is required for performing both encryption as well as decryption.

D_{B} can be made to perform blinded encryption as follows. D_{A} chooses a random z, and its exponentiative inverse z⁻¹. Next, D_{A} computes M^{z} mod p, sends it to D_{B}, with the request to “encrypt.” D_{B} then raises M^{z} mod p to x, and performs a modulo p operation on the result, to obtain M^{zx} mod p. D_{B} sends this value to D_{A}, which raises the value to z⁻¹ to obtain M^{x} mod p. The encryption performed by D_{B} is blind because D_{B} cannot determine M unless it knows z⁻¹.

D_{B} can be made to perform blinded decryption of M^{x} mod p as follows. D_{A} chooses a random y, and its exponentiative inverse y⁻¹. Next, D_{A} computes M^{xy} mod p, sends it to D_{B}, with the request to “decrypt.” D_{B} then raises M^{xy} mod p to x⁻¹, and performs a modulo p operation on the result, to obtain M^{y} mod p. D_{B} sends this value to D_{A}, which raises the value to y⁻¹ to obtain M. The decryption performed by D_{B} is blind because D_{B} cannot determine M unless it knows y⁻¹.

If D_{A} and D_{B} collude, D_{B} can determine M. However, device D_{C}, which sits between D_{A} and D_{B}, can prevent D_{B} from determining M by performing an additional level of blinding. When D_{A} wants to encrypt M, it sends to D_{B} the message: “M^{z} mod p, i, encrypt.” D_{C} intercepts the message, chooses its own random number q, raises M^{z} mod p to q, and forwards the following message to D_{B}: “M^{zq} mod p, i, encrypt.” D_{B} raises M^{zq} mod p to x and returns M^{zqx} mod p (assuming that x is the encryption key associated with identifier i). D_{C} intercepts this, raises M^{zqx} mod p to q⁻¹ (exponentiative inverse of q), performs a modulo p operation, and sends the result M^{zx} mod p to D_{A}. D_{A} unblinds by raising M^{zx} mod p to z⁻¹, to obtain M^{x} mod p.

To perform an additional level of blinding during decryption, D_{A} chooses w and computes its exponentiative inverse w⁻¹. D_{A} computes M^{xw} mod p, and sends to D_{B} the message: “M^{xw} mod p, i, decrypt.” D_{C} intercepts, chooses a value f and computes its exponentiative inverse f⁻¹. D_{C} then computes M^{xwf} mod p and sends to D_{B} the message: “M^{xwf} mod p, i, decrypt.” D_{B} raises M^{xwf} mod p to x⁻¹, and returns M^{wf} mod p. D_{C} intercepts, raises M^{wf} mod p to f⁻¹, and returns M^{w} mod p to D_{A}. D_{A} then raises M^{w} mod p to w⁻¹ to obtain M. Note that the above-described technique can be extended to multiple levels of blinding.

### Content Delivery

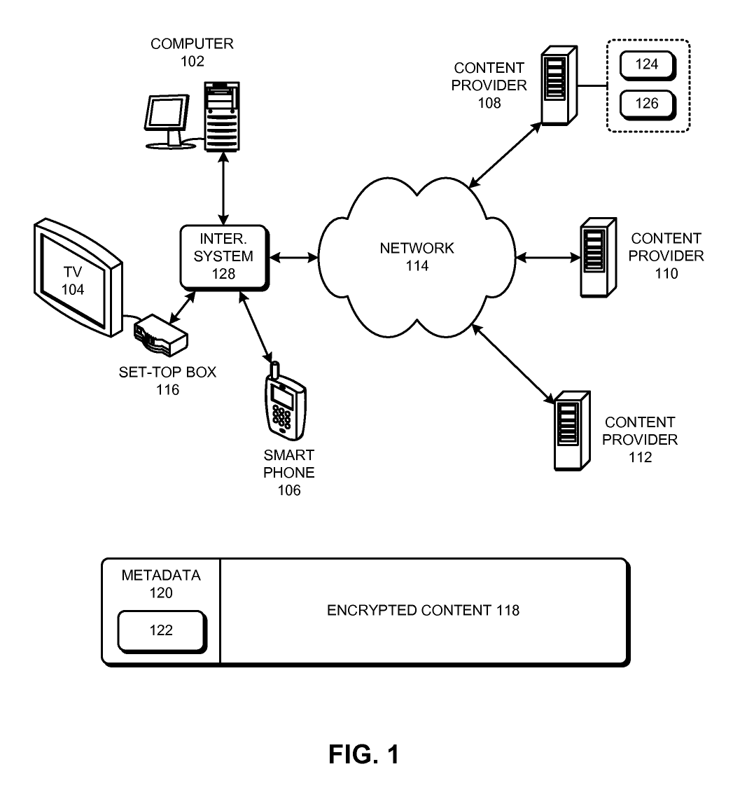

FIG. 1 illustrates how private information can be covertly revealed when a user consumes content.

Content can generally refer to any information that a user desires to consume. A user can consume content using any device that enables the user to consume information. For example, a user can use computer 102, television 104, or smart phone 106 to consume content. Specifically, a user may view a video on television 104; listen to music on smart phone 106; read a book or view a web page on computer 102; or play a video game on computer 102.

Content can be obtained from a content provider which can generally be a system or collection of systems which enable a user to obtain content. A content provider may enable a user to consume one or more types of content. For example, a user can obtain content from content providers 108, 110, and 112 via network 114. Content provider 108 can be an online music store which enables users to download or stream music files. Content provider 110 can be a real-time multimedia server which enables users to receive real-time multimedia content, e.g., a video news feed. Content provider 112 can be a gaming server which enables users to play online video games. A content provider can also be a file server which enables a user to access files.

Network 114 can generally include any type of wired or wireless communication channel(s) capable of coupling together computing nodes. This includes, but is not limited to, a local area network, a wide area network, an intranet, the Internet, or a combination of networks.

A content provider may place a device or software at the user's premises to facilitate content consumption. According to one definition, a device or software can be considered to be within a user's premises if the user can access communications between the device or software and another system. For example, a content provider may require that a user use set-top box 116 to receive video content. Similarly, a content provider may place a proprietary software application on computer 102 or smart phone 106 to facilitate content delivery.

The content provider may use such devices or software to ensure that the user does not access unauthorized content (e.g., content which the user did not purchase). For example, the device or software located at a user's premises can be tamper proof to prevent a user from performing unauthorized actions or to prevent the user from accessing unauthorized content.

Content can be delivered using many approaches. For example, in one approach, set-top box 116 can receive encrypted content 118 and metadata 120. The encrypted content 118 may be received from content provider 108, or it may be received from a third-party system which distributes encrypted content for content provider 108. Metadata 120 can contain information which can enable set-top box 116 to decrypt the encrypted content. For example, content provider 108 may be associated with private key 124 and public key 126, and metadata 120 may include encrypted content-key 122 which is encrypted using content provider 108's public key 126. Note that public key 126 may be publicly known so that a third-party distributor can encrypt the content key using public key 126 to obtain encrypted content-key 122. The encrypted content-key 122 when decrypted can be used for decrypting encrypted content 118.

Once the user satisfies the conditions for consuming the content (e.g., by purchasing the content), set-top box 116 can send encrypted content-key 122 to content provider 108. Next, content provider 108 can use private key 124 to decrypt encrypted content-key 122, and send the decrypted key to set-top box 116, thereby enabling set-top box 116 to decrypt encrypted content 118.

The user may use a device, e.g., a router, to enable devices in the user's network to communicate with the rest of the world. Specifically, some or all communications between a device within a user's network and the outside world may pass through this particular device. For example, in FIG. 1, all communications between set-top box 116 and content provider 108 may pass through intermediate system 128, whereas only some communications (e.g., only data packets) between smart phone 106 and content provider 110 may pass through intermediate system 128.

Intermediate system 128 can generally be any device capable of facilitating communication between two or more devices. Intermediate system 128 includes, but is not limited to, a wired or wireless router or switch, a network interface card, a computer, or any other communication device now known or later developed.

Often, a user has limited or no control over the content provider's device or software. For example, a user may have very limited control over the information that set-top box 116 sends or the actions that set-top box 116 performs. Note that, even if the user has access to all communications between the content provider's device and the rest of the world (e.g., via intermediate device 128), the user may not be able to control or decipher what information is being communicated. Hence, in such scenarios, the user has to trust the content provider that the equipment or software that the content provider has placed on the user's premises will not communicate any information that the user does not want the equipment or software to communicate.

In some cases, the content provider's device or software may perform a blinding operation on private information before sending the information to the content provider. For example, suppose a user wants to decrypt an encrypted content-key without revealing the metadata and/or the content key to a content provider because that would reveal the content that the user bought. In this case, set-top box 116 may perform a blinding operation on encrypted content-key 122 to obtain a blinded-and-encrypted content-key. Next, the set-top box 116 may send the blinded-and-encrypted content-key to content provider 108 for decryption. Since the encrypted content-key is blinded, content provider 108 should not be able to obtain the content-key.

However, if set-top box 116 either uses a weak form of blinding or if it colludes with content provider 108, content provider 108 may obtain private information without the user's knowledge. Note that, when set-top box 116 uses a weak blinding operation or colludes with content provider 108, it creates a covert channel which set-top box 116 can use to communicate private information to content provider 108. A weak blinding operation is a blinding operation that can be broken with relative ease.

A user can use intermediate system 128 to detect whether set-top box 116 is communicating private information. For example, if intermediate system 128 determines that the size of the message being sent by set-top box 116 is larger than expected, it can alert the user. Further, intermediate system 128 can determine if set-top box 116 performed a blinding operation by noting that the message that set-top box 116 is sending contains data that is different from the metadata that was received. However, the user cannot determine whether set-top box 116 is communicating private information via a covert channel, e.g., by using a weak blinding operation or by colluding with content provider 108. Embodiments of the present invention enable a user to ensure that set-top box 116 does not communicate private information to content provider 108 over a covert channel.

Set-top box 116 may also covertly send private information in the authentication information. Some authentication techniques may not allow intermediate system 128 to ensure that the authentication information does not contain private information. For example, if the authentication information is generated by hashing information with a secret key, intermediate system 128 may not be able to know what information was hashed. However, if the authentication information is generated by encrypting information using set-top box 116's private key, intermediate system 128 can use set-top box 116's public key to decrypt the encrypted information to check that private information is not being sent in the authentication information.

The systems, techniques, and the types of content shown in FIG. 1 are for illustration purposes only and are not intended to limit the present invention. In general, accessing and/or consuming content may require communication between multiple hardware and/or software entities, and a user may want to ensure that these hardware and/or software entities do not send the user's private information over a covert channel by using weak blinding operations and/or colluding with one another. Embodiments of the present invention can be used in any situation where a party desires to ensure that a communication does not covertly reveal private information.

### Process for Assuring Enhanced Security

A source system (e.g., a set-top box) may request a destination system (e.g., a content-provider's server) to perform a transformation operation (e.g., an asymmetric decryption operation) on private information (e.g., an encrypted content-key). Note that the source may perform an initial blinding operation on the private information to obtain blinded information.

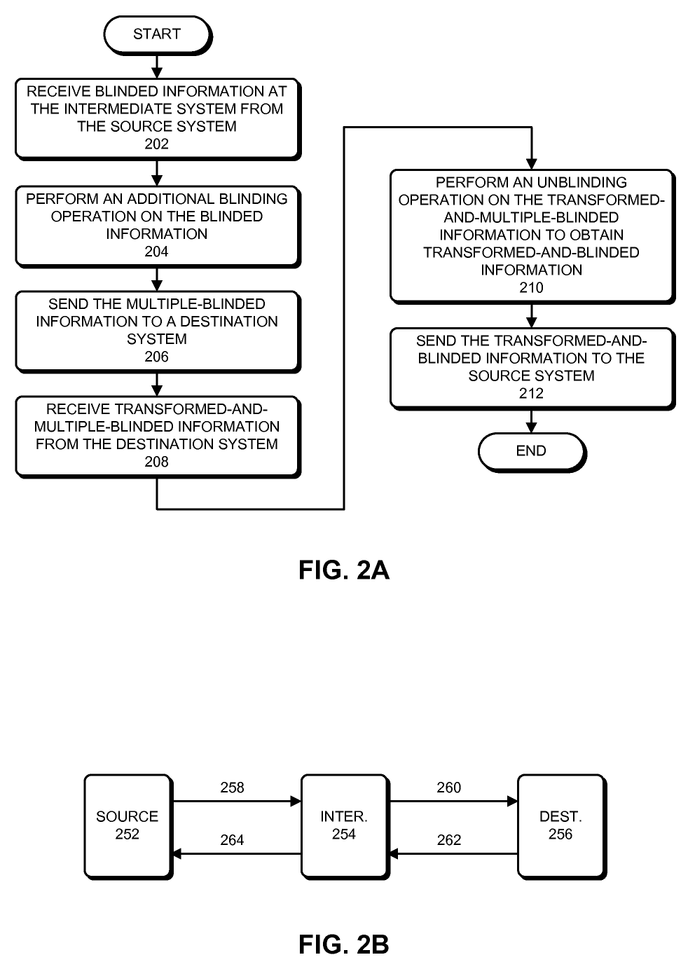

FIG. 2A presents a flowchart that illustrates a process for an intermediate system to ensure that a source system does not reveal private information to a destination system in accordance with an embodiment of the present invention. Note that all communications between the source system and the destination system pass through the intermediate system.

The process can begin by receiving the blinded information at the intermediate system from the source system (block 202). Note that the blinded information is destined to the destination system.

The intermediate system can then perform an additional blinding operation on the blinded information (block 204) to obtain multiple-blinded information. Performing the additional blinding operation on the blinded information prevents the destination system from unblinding the blinded information to obtain the private information.

Next, the intermediate system can send the multiple-blinded information to the destination system (block 206), thereby ensuring that the private information is not revealed to the destination system. In other words, at this point in the process, the intermediate system has already ensured that the destination system will not be able to access the private information.

The destination system can then receive the multiple-blinded information, and perform a transformation operation on the multiple-blinded information to obtain transformed-and-multiple-blinded information. The destination system can then send the transformed-and-multiple-blinded information to the intermediate system.

The transformation operation can be any operation that commutes with a blinding operation. In some embodiments, the transformation operation is an asymmetric encryption or decryption operation, e.g., an RSA encryption or decryption operation, a Diffie-Hellman encryption or decryption operation, or a Pohlig-Hellman encryption or decryption operation.

If the intermediate system knows what transformation operation the destination system is expected to perform, the intermediate system can choose an appropriate blinding operation that commutes with the transformation operation. For example, if the intermediate system knows that the destination system is expected to perform RSA encryption or decryption, the intermediate system can perform a blinding operation that commutes with RSA encryption or decryption (an example of such a blinding operation was described in an earlier section).

Next, the intermediate system can receive the transformed-and-multiple-blinded information from the destination system (block 208).

The intermediate system can then perform an unblinding operation on the transformed-and-multiple-blinded information to obtain transformed-and-blinded information (block 210). Note that the unblinding operation is the inverse of the blinding operation that the intermediate system performed in block 204.

Next, the intermediate system can send the transformed-and-blinded information to the source system (block 212). The source system can then perform its own unblinding operation, which is the inverse of the blinding operation that the source system had performed, to obtain the transformed information.

FIG. 2B illustrates how an intermediate system can ensure that a source system does not reveal private information to a destination system in accordance with an embodiment of the present invention.

Source system 252 can send blinded information to destination system 256, which may be intercepted by intermediate system 254 (communication 258). Next, intermediate system 254 can perform a blinding operation and send the result to destination system 256 (communication 260). Destination system 256 can then perform a transformation operation and send the result to source system 252, which may be intercepted by intermediate system 254 (communication 262). Next, intermediate system 254 can perform an unblinding operation and send the result to source system 252 (communication 264). Finally, source system 252 can perform an unblinding operation to obtain the desired result.

Communications between a source system and a destination system may use end-to-end authentication to prevent man-in-the-middle attacks. In such situations, an intermediate system may not be able to modify communications between the source system and the destination system.

However, even in the presence of end-to-end authentication, some embodiments of the present invention allow an intermediate system to ensure that a source system does not reveal private information to a destination system over a covert channel. For example, an intermediate system can receive information from a source system, which is destined to a destination system. Next, the intermediate system can request the source system to perform a modification operation on the information. Performing the modification operation on the information can assure the intermediate system of an enhanced level of security. Note that since the intermediate system requests the source system to perform the modification operation, the end-to-end integrity of the communication is not compromised. The intermediate system can then receive the modified information from the source system. Next, the intermediate system can check that the source system performed the requested modification operation, thereby assuring enhanced security.

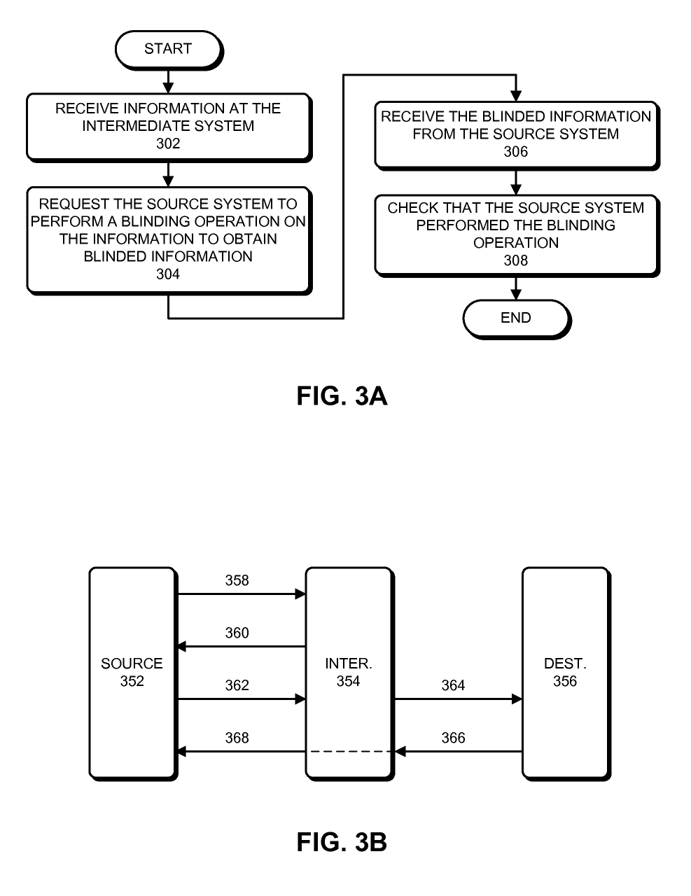

FIG. 3A presents a flowchart which illustrates a process for an intermediate system to ensure that a source system does not reveal private information to a destination system in accordance with an embodiment of the present invention.

The process can begin by receiving information at the intermediate system (block 302). The information may be generated by the source system or by some other system by performing an asymmetric encryption operation using an asymmetric key associated with the destination system. The information may also be blinded by performing a blinding operation either after or before the encryption operation. In other words, the information received at the intermediate system from the source system can be encrypted, or blinded, or both. Further, the blinding operation that was performed to generate the information may be “untrustworthy” in that the intermediate system may not trust the blinding operation's efficacy in hiding private information.

Note that, at this point, the source system has committed the information it intends to send to the destination system. Next, the intermediate system can request the source system to perform a blinding operation on the information to obtain blinded information (block 304). For example, if the blinding operation is for RSA, the intermediate system can choose a random number, and request that the source system perform blinding using the chosen random number. Since the destination system cannot determine the random number that was chosen by the intermediate system, the destination system will not be able to perform unblinding.

The intermediate system can then receive the blinded information from the source system (block 306). Next, the intermediate system can check that the source system performed the blinding operation (block 308), thereby ensuring that the private information is not revealed to the destination system. Note that, since the intermediate system does not modify the message, end-to-end-authentication between the source system and the destination system is not broken.

The intermediate system can perform the checking by performing an unblinding operation on the blinded information to obtain unblinded information, and compare the unblinded information with the information that the source system committed to send to the destination system. Alternatively, the intermediate system can perform the blinding operation on the information committed by the source system to obtain a result of the blinding operation, and compare the result of the blinding operation with the blinded information that the intermediate system received from the source system.

Further, the intermediate system can generate an indicator that indicates the result of the checking operation, and store the indicator in a computer-readable storage medium, or display the indicator to the user. For example, if the indicator indicates that the source system did not perform the blinding operation, the intermediate system can alert the user.

FIG. 3B illustrates how an intermediate system can ensure that a source system does not reveal private information to a destination system in accordance with an embodiment of the present invention.

Source system 352 can send information to intermediate system 354, or it may send the information to destination system 356, which may be intercepted by intermediate system 354 (communication 358). The information may be encrypted, or blinded, or both. Next, intermediate system 354 can request source system 352 to perform a blinding operation (communication 360). In response, source system 352 can perform the blinding operation on the information and send the result to intermediate system 354 or destination system 356, which may be intercepted by intermediate system 354 (communication 362). Intermediate system 354 can check if source system 352 performed the blinding operation, and if it did, intermediate system can send the blinded information to destination system 356 (communication 364).

Destination system 356 can then perform a transformation operation, e.g., asymmetric decryption, and send the result back to intermediate system 354 or source system 352, which may be intercepted by intermediate system 354 (communication 366). If the information was sent to intermediate system 354, it can perform an unblinding operation and send the result to source system 352 (communication 368). Alternatively, if the destination system sent the result directly to source system 352, the intermediate system may intercept the communication and forward it to source system 352 without making any changes. Finally, source system 352 can perform an unblinding operation to obtain the desired result.

In cryptographic protocols that use a random nonce, private information can be revealed over a covert channel by choosing a non-random nonce, e.g., a source system and a destination system may use the nonce to covertly communicate information.

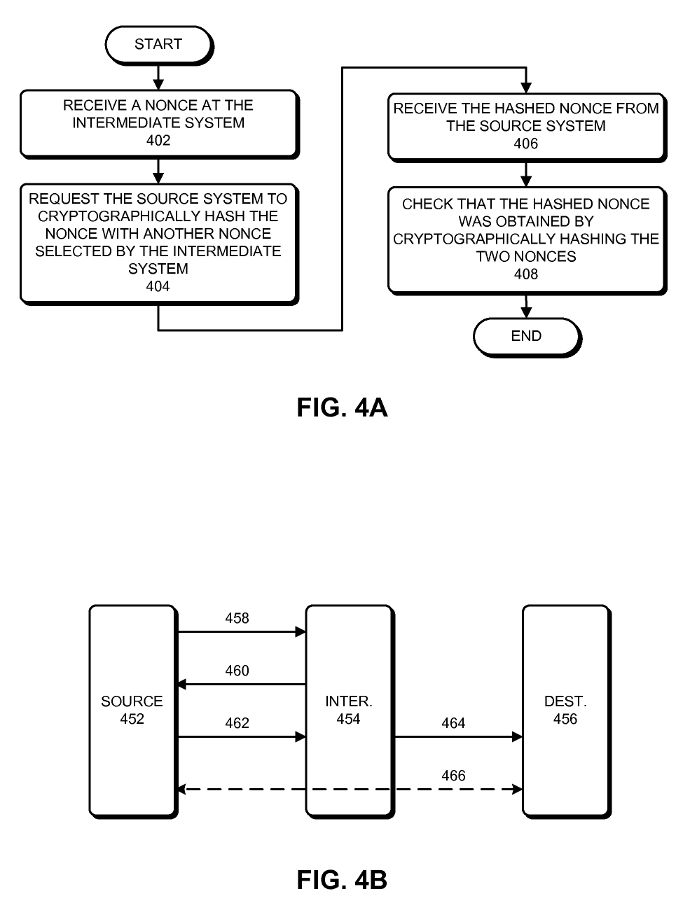

FIG. 4A presents a flowchart that illustrates a process to enable an intermediate system to ensure that a nonce which is being used in a cryptographic protocol between a source system and a destination system is randomly chosen, thereby ensuring that the source system cannot use the nonce to covertly reveal private information, in accordance with an embodiment of the present invention.

The process can begin by receiving a nonce at the intermediate system (block 402). The nonce is selected by the source system for use in the cryptographic protocol which requires a nonce to be randomly chosen. The intermediate system may intercept the nonce when the source system attempts to use it in the cryptographic protocol.

Next, the intermediate system can request the source system to cryptographically hash the nonce with another nonce selected by the intermediate system (block 404). The result of the hashing operation is a hashed nonce which can be used in the cryptographic protocol.

The intermediate system can then receive the hashed nonce from the source system (block 406). Next, the intermediate system can check that the source system obtained the hashed nonce by cryptographically hashing the two nonces (block 408), thereby ensuring that the nonce which is being used in the cryptographic protocol between the source system and the destination system is randomly chosen. Specifically, the intermediate system can perform the check by cryptographically hashing the two nonces to obtain a hash result, and comparing the hash result with the hashed nonce. Note that, cryptographically hashing the two nonces ensures that neither the source system nor the intermediate system is able to cause a non-random nonce to be used in the cryptographic protocol.

FIG. 4B illustrates how an intermediate system can ensure that a nonce that is being used in a cryptographic protocol between a source system and a destination system is randomly chosen in accordance with an embodiment of the present invention.

Source system 452 can send a nonce to intermediate system 454, or it can send the nonce to destination system 456, which may be intercepted by intermediate system 454 (communication 458). Next, intermediate system 454 can choose another nonce, and request source system 452 to cryptographically hash the two nonces (communication 460). In response, source system 452 can hash the two nonces and send the result to intermediate system 454, or send it to destination system 456, which may be intercepted by intermediate system 454 (communication 462). Intermediate system 454 can check if source system 452 cryptographically hashed the two nonces, and if it did, intermediate system can send the hashed nonce to destination system 456 (communication 464). Source system 452 and destination system 456 can then use the hashed nonce in the cryptographic protocol (communications 466).

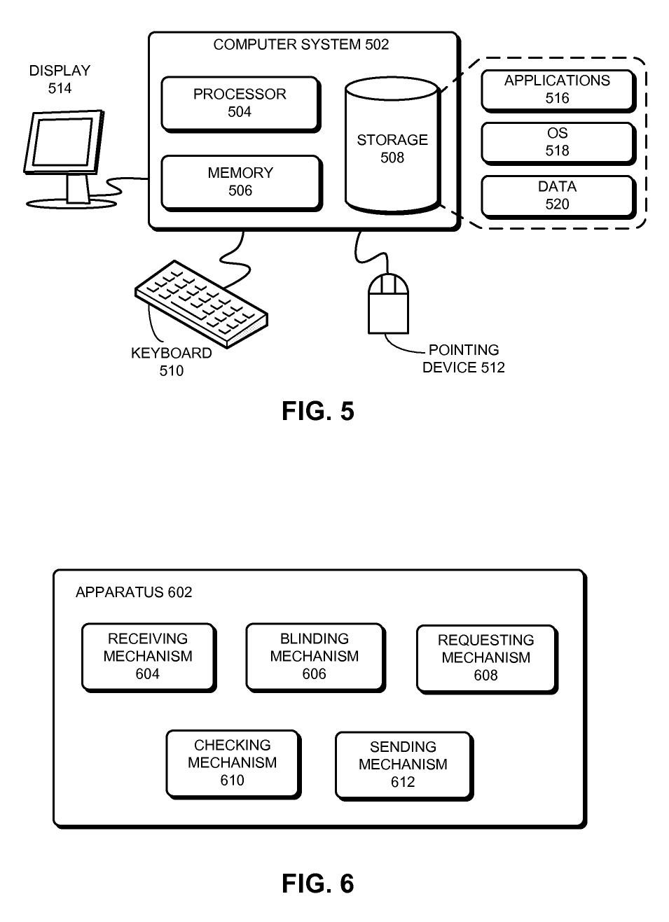

FIG. 5 illustrates a computer system in accordance with an embodiment of the present invention.

A computer system can generally be any system that can perform computations. Specifically, a computer system can be a microprocessor, a network processor, a portable computing device, a personal organizer, a device controller, or a computational engine within an appliance, or any other computing system now known or later developed. Computer system 502 comprises processor 504, memory 506, and storage 508. Computer system 502 can be coupled with display 514, keyboard 510, and pointing device 512. Storage 508 can generally be any device that can store data. Specifically, a storage device can be a magnetic, an optical, or a magneto-optical storage device, or it can be based on flash memory and/or battery-backed up memory. Storage 508 can store applications 516, operating system 518, and data 520.

Applications 516 and/or operating system 518 can perform processes to ensure that private information is not revealed over a covert channel. Data 520 can include secrets, seeds, keys, certificates, nonces, and any other information that may be required for performing cryptographic operations.

FIG. 6 illustrates an apparatus in accordance with an embodiment of the present invention.

Apparatus 602 can comprise a number of mechanisms which may communicate with one another via a wired or wireless communication channel. Apparatus 602 may be realized using one or more integrated circuits, and it may be integrated in a computer system, or it may be realized as a separate device which is capable of communicating with other computer systems and/or devices. Specifically, apparatus 602 can comprise receiving mechanism 604, blinding mechanism 606, requesting mechanism 608, checking mechanism 610, and sending mechanism 612. In some embodiments, receiving mechanism 604 may be configured to receive information, blinding mechanism 606 may be configured to perform a blinding operation on the information, requesting mechanism 608 may be configured to request another system to perform an operation on the information, checking mechanism 610 may be configured to check if the source system performed the requested operation (e.g., blinding or hashing), and sending mechanism 612 may be configured to send information to another system.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for an intermediate system to assure enhanced security, the method comprising:
receiving blinded information at the intermediate system, wherein the blinded information is received from a source system, and is destined to a destination system, and wherein the blinded information is generated by at least performing a first blinding operation on information;
performing a second blinding operation on the blinded information to obtain multiple-blinded information; and
sending the multiple-blinded information to the destination system.

2. The method of claim 1, wherein the method comprises:
performing, at the source system, at least the first blinding operation on the information to obtain the blinded information; and
sending the blinded information to the intermediate system.

3. The method of claim 2, wherein the method comprises:
receiving the multiple-blinded information at the destination system;
performing, at the destination system, a transformation operation on the multiple-blinded information to obtain transformed-and-multiple-blinded information, wherein the first blinding operation and the second blinding operation commute with the transformation operation; and
sending the transformed-and-multiple-blinded information to the intermediate system.

4. The method of claim 3, wherein the method comprises:
receiving the transformed-and-multiple-blinded information at the intermediate system;
performing, at the intermediate system, a second unblinding operation on the transformed-and-multiple-blinded information to obtain transformed-and-blinded information, wherein the second unblinding operation is the inverse of the second blinding operation; and
sending the transformed-and-blinded information to the source system.

5. The method of claim 4, wherein the method comprises:
receiving the transformed-and-blinded information at the source system; and
performing, at the source system, a first unblinding operation on the transformed-and-blinded information to obtain transformed information, wherein the first unblinding operation is the inverse of the first blinding operation.

6. The method of claim 3, wherein the information includes an encrypted content key which was obtained by performing an asymmetric encryption operation on a content key which encrypts content purchased by a user, and wherein the asymmetric encryption operation was performed using a public key which is associated with the destination system.

7. The method of claim 6, wherein performing the transformation information involves performing an asymmetric decryption operation on the multiple-blinded information using a private key associated with the destination system.

8. The method of claim 7, wherein the asymmetric encryption operation performs RSA encryption, and wherein the asymmetric decryption operation performs RSA decryption.

9. The method of claim 7, wherein the asymmetric encryption operation performs Diffie-Hellman encryption, and wherein the asymmetric decryption operation performs Diffie-Hellman decryption.

10. The method of claim 7, wherein the asymmetric encryption operation performs Pohlig-Hellman encryption, and wherein the asymmetric decryption operation performs Pohlig-Hellman decryption.

11. A computer-implemented method for an intermediate system to assure enhanced security, the method comprising:
receiving information from a source system, wherein the information is destined to a destination system;
requesting the source system to perform a modification operation on the information;
receiving modified information from the source system; and
checking that the source system performed the modification operation.

12. The method of claim 11, wherein checking that the source system performed the modification operation involves:
performing, at the intermediate system, the modification operation on the information to obtain a result; and
comparing the result with the modified information.

13. The method of claim 11, wherein an inverse of the modification operation exists, and wherein checking that the source system performed the modification operation involves:
performing, at the intermediate system, the inverse of the modification operation on the modified information to obtain a result; and
comparing the result with the information.

14. The method of claim 11, further comprising:
in response to determining that the source system performed the modification operation, sending the modified information to the destination system; and
in response to determining that the source system did not perform the modification operation, reporting an error.

15. The method of claim 14, wherein an inverse of the modification operation exists and the modification operation commutes with a transformation operation, and wherein the method further comprises:
receiving the modified information at the destination system;
performing, at the destination system, the transformation operation on the modified information to obtain transformed-and-modified information; and
sending the transformed-and-modified information to the intermediate system.

16. The method of claim 15, further comprising:
receiving the transformed-and-modified information at the intermediate system;
performing, at the intermediate system, the inverse of the modification operation on the transformed-and-modified information to obtain transformed information; and
sending the transformed information to the source system.

17. The method of claim 11, wherein the modification operation includes a blinding operation.

18. The method of claim 11, wherein the modification operation includes a cryptographic hashing operation.

19. A computer-readable storage medium storing instructions that when executed by an intermediate system cause the intermediate system to perform a method to assure enhanced security, the method comprising:
receiving information from a source system, wherein the information is destined to a destination system;
requesting the source system to perform a modification operation on the information;
receiving modified information from the source system; and
checking that the source system performed the modification operation.

20. The computer-readable storage medium of claim 19, wherein the method further comprises:
in response to determining that the source system performed the requested modification, sending the modified information to the destination system; and
in response to determining that the source system did not perform the requested modification, reporting an error.
